(19) United States
(12) Patent Application Publication
(10) Pub. No.: US 2004/0263647 A1
(43) Pub. Date: Dec. 30, 2004

(54) Drive recorder

(75) Inventor: Takeshi Yamaguchi, Kanagawa (JP)

Correspondence Address: BROWDY AND NEIMARK, P.L.L.C., 624 NINTH STREET, NW, SUITE 300, WASHINGTON, DC, 20001-5303, US

(73) Assignee: MATSUSHITA ELECTRIC INDJUSTRIAL CO., LTD., Osaka (JP)

(21) Appl. No.: 10/781,919

(22) Filed: Feb. 20, 2004

(30) Foreign Application Priority Data
Jun. 24, 2003 (JP) 2003-180012

(51) Int. Cl. H04N 7/18; H04N 9/47; H04N 5/222

(52) U.S. Cl. 348/240.2; 348/148; 348/333.02

(57) ABSTRACT

A drive recorder attains scenic images surrounding a vehicle or images inside a vehicle chamber in a specific direction, as being useful for verifying a cause of an accident. As an impact sensor detects an occurrence of an accident, a control unit displays an image by an on-vehicle camera on a screen of a display. Accordingly, a user is able to quickly record target objects that supposedly help to verify the cause of the accident, such as the vehicle running into from behind and running away, a traffic light, a traffic marking and so forth, by simply turning a photographic direction of the on-vehicle camera toward the target objects, with a simple operation on a touch panel, even in an emergency.

### BACKGROUND OF THE INVENTION

1. Field of the Invention

The present invention relates to a drive recorder that records a travel state of a vehicle, specifically to a drive recorder capable of recording the circumstances of an accident and so forth by recording the environments of the vehicle.

2. Description of the Related Art

A conventional vehicle drive recorder is a device that, when there occurs an antipersonnel accident or an impersonal accident of a vehicle, pursues the cause of the accident. The drive recorder analyzes the travel state of the vehicle on the basis of the recorded signals of vehicle sensors relating to the vehicle speed, acceleration, braking pressure, and steering angle and so forth before and after the accident, and investigates the cause of the accident. There is another proposal that incorporates a camera to photograph the environments of the vehicle and records photographed images by the camera together with the recorded signals to thereby clarify the circumstances when the accident occurs. This type of conventional vehicle drive recorder is disclosed, for example, in Japanese Published Unexamined Patent Application No. 2000-6854. This drive recorder sequentially updates the oldest data of the photographed images during travel of a vehicle to make a continuous recording. When determining the occurrence of an accident by the operation of an impact sensor, the drive recorder halts the recording and transfers the recorded images to a recording storage unit.

However, the conventional drive recorder sets a fixed position to the camera that photographs the environments of the vehicle. Since the camera photographs mainly the forward circumstances while the vehicle travels, the camera does not necessarily photograph the image in a specific direction or the specific objective image that can be the cause of an accident. Thus, the conventional drive recorder has to rely on a chance as to whether the accident is photographed or not. In the case of an accident of a vehicle running into from behind, for example, the image of the vehicle running into, the color of the traffic light, the traffic sign, and the traffic marking, etc. when the accident occurred can be an important clue to the investigation of the accident.

The invention intends to solve the above conventional problem, and provides a drive recorder capable of photographing an image in a specific direction when an accident occurs.

### SUMMARY OF THE INVENTION

In order to solve the above problem, the drive recorder of the invention includes: a camera that photographs images of the outside or inside of a vehicle, a recording unit that records images photographed by the camera, a display that displays the recorded images on a screen, a touch panel, disposed on a front of the screen of the display, that outputs coordinate data of a position pressed, and photographic direction variation means that vary a photographic direction of the camera in accordance with the position pressed on the touch panel. This configuration enables the drive recorder to put on the display the image surrounding the vehicle when an accident occurs. When the user presses a specific position of the image put on the display, for example, a traffic light, the touch panel on the front of the display outputs the coordinate data of the position pressed by the user, and the photographic direction variation means turns the camera toward the specific position on the basis of the coordinate data thereof. Therefore, the user is able to quickly and easily photograph the image in a specific direction that can be important evidence at the occurrence of the accident.

Further, in the drive recorder of the invention, the photographic direction variation means may include: a reference table that determines coordinates on the display screen corresponding to the position pressed, from the coordinates of the position pressed on the touch panel, a camera movement calculation unit that calculates a movement of the camera from the coordinates on the display screen corresponding to the position pressed on the touch panel, and a photographic direction switch unit that moves the camera on the basis of the movement calculated. This configuration allows the user to turn the camera toward the position of the target object, just by pressing the specific position of the image presented on the display.

Further, in the drive recorder of the invention, the photographic direction switch unit may include: a drive control unit that receives a movement of the camera from the camera movement calculation unit to generate a camera drive signal, a camera drive unit that drives the photographic direction of the camera in a horizontal direction and an elevation-angle direction, in accordance with the camera drive signal from the drive control unit, and a counter that reads angles of the horizontal direction and the elevation-angle direction driven by the camera drive unit, and transmits read values of the angles to the drive control unit. Owing to this configuration, the angles of the direction to which the camera is driven are transmitted to the drive control unit, and thereby the user is able to precisely switch the direction of the camera.

Further, the drive recorder of the invention may include photographic magnification switch means that switch a photographic magnification of the camera, and the camera movement calculation unit may be designed to calculate a movement of the camera corresponding to the photographic magnification. Owing to this configuration, the user is able to specify a farther or a nearer position of the image presented on the screen of the display.

Further, the drive recorder of the invention may include a communication unit that communicates with an external organization, and screen capture means that fetch an image presented on the display. Further, the drive recorder may be configured to record the image by the camera presented on the display as a static image, and the communication unit may be designed to transmit the static image with information inherent to the vehicle attached. This configuration allows the user to quickly transmit useful images leading to verifying the cause of the accident to an external organization with a simple operation.

As described above, since the drive recorder of the invention includes the photographic direction variation means that switches the photographic direction of the camera to interlock with the operation on the touch panel, the user is able to record the image in a desired direction with a simple operation. And, since the touch panel is incorporated on the front of the display, the user is able to securely record the image in a desired direction.

The foregoing and other objects and features of the invention will become apparent by the following descriptions made in conjunction with the appended drawings.

### BRIEF DESCRIPTION OF THE DRAWINGS

FIG. 1 is a block diagram illustrating a configuration of a drive recorder in the embodiment 1 of the invention;

FIG. 2 is a typical chart illustrating an example of setting a camera in a vehicle chamber in the embodiment 1;

FIG. 3 is a block diagram illustrating a configuration of a photographic direction switch unit in the embodiment 1;

FIG. 4 is an explanatory chart for detecting a position where a touch panel is pressed in the embodiment 1;

FIG. 5 is an explanatory chart for the display coordinates in the embodiment 1;

FIG. 5B is an explanatory chart for the positional correspondence between the touch panel and the display in the embodiment 1;

FIG. 6 is a flowchart illustrating the operation of the drive recorder in the embodiment 1;

FIG. 7 is an explanatory chart for a display screen in the embodiment 1;

FIG. 8 is a flowchart illustrating the processing operation of varying the photographic direction in the embodiment 1;

FIG. 9 is an explanatory chart for calculating a variation of a photographic direction in the embodiment 1;

FIG. 10 is an explanatory chart for operating screen of a photographic magnification in the embodiment 1;

FIG. 11 is a block diagram illustrating another configuration of the drive recorder in the embodiment 1;

FIG. 12 is a block diagram illustrating a configuration of a drive recorder in the embodiment 2 of the invention;

FIG. 13 is an explanatory chart for an operating screen in the embodiment 2; and

FIG. 14 is a flowchart illustrating the operation of the drive recorder in the embodiment 2.

### DESCRIPTION OF THE PREFERRED EMBODIMENTS

The embodiments of the invention will now be described with reference to accompanying drawings.

(Embodiment 1)

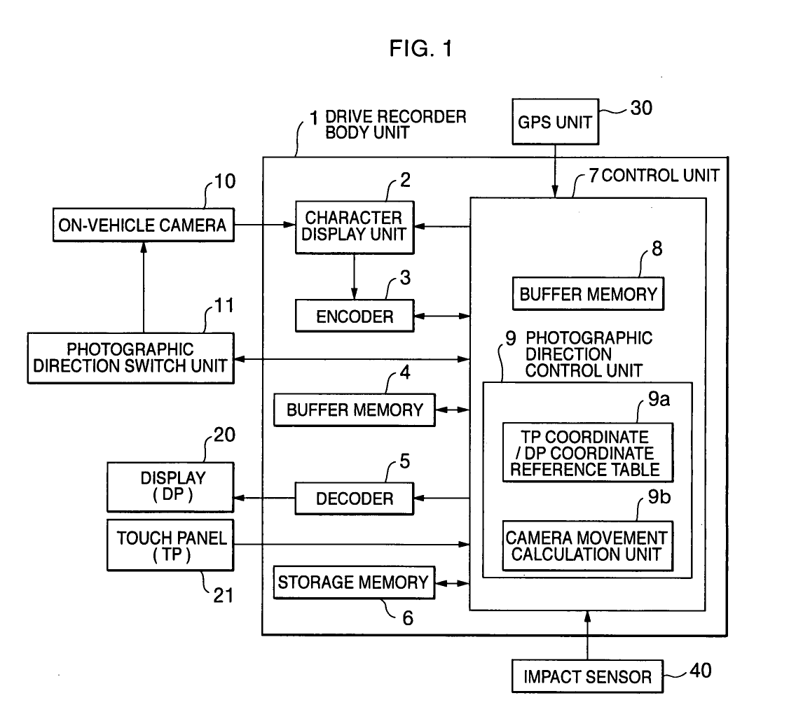

FIG. 1 illustrates a configuration of the drive recorder in the embodiment 1 of the invention. In FIG. 1, the drive recorder includes, as the peripheral devices connected to a drive recorder body unit 1, an on-vehicle camera 10 using a CCD that photographs the surrounding scenes outside a vehicle and the circumstances inside a vehicle chamber, a photographic direction switch unit 11 that switches the photographic direction of the on-vehicle camera 10, a display (DP) 20 that displays the images of the surrounding scenes or the circumstances inside the chamber, which are photographed by the on-vehicle camera 10, a touch panel (TP) 21, placed on the front of the screen of the display 20, that outputs the coordinate data of a position pressed by a user, a GPS unit 30 that detests the current position of the own vehicle by use of the Global Positioning System, and an impact sensor 40 that detects an external impact on the vehicle more than a specified value.

The drive recorder body unit 1 includes a character display unit 2, an encoder 3, a buffer memory 4, a decoder 5, a storage memory 6, and a control unit 7. The control unit 7 includes a buffer memory 8 and a photographic direction control unit 9. The photographic direction control unit 9 includes a TP coordinate/DP coordinate reference table 9a and a camera movement calculation unit 9b that calculates a movement of the on-vehicle camera 10. The photographic direction control unit 9 and the photographic direction switch unit 11 makes up a photographic direction varying means.

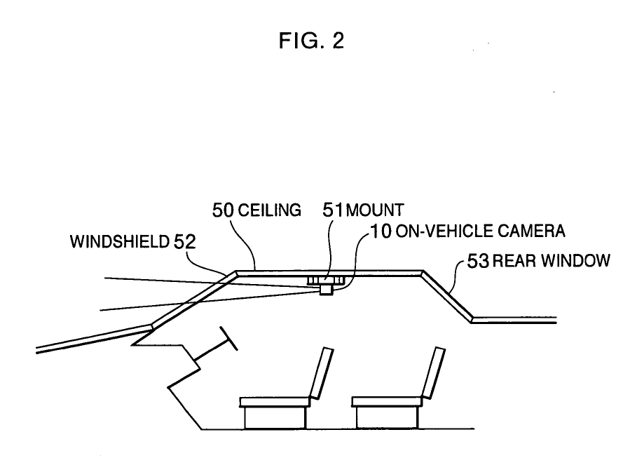

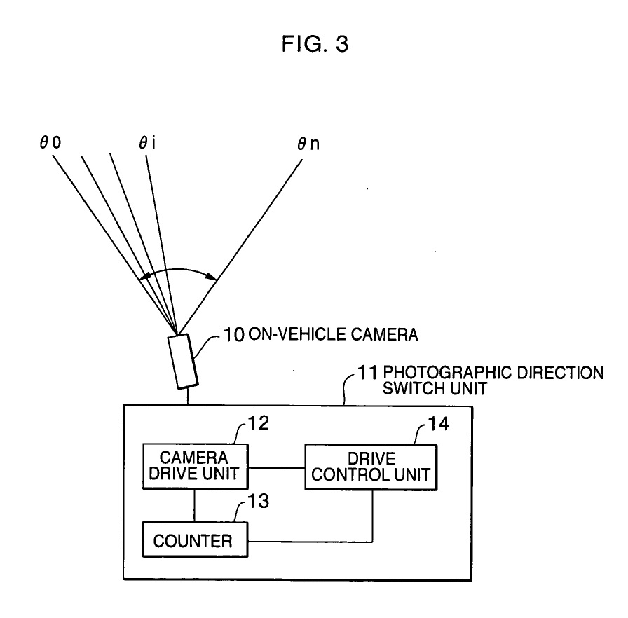

The on-vehicle camera 10 is installed, as shown in FIG. 2 for example, on a chamber ceiling 50 with intervention of a mount 51. The operation of the photographic direction switch unit 11 makes it possible to vary the photographic direction of the on-vehicle camera 10, to photograph the scenes outside the vehicle in a specific direction through a windshield 52 or a rear window 53, and to photograph the circumstances of the drive seat, front passenger seat, rear seat, etc., inside the vehicle. The photographic direction switch unit 11 includes a camera drive unit 12 with a panning mechanism and a tilting mechanism built in the mount 51, a counter 13, and a drive control unit 14, as shown in FIG. 3. The camera drive unit 12 drives the photographic direction of the on-vehicle camera 10 in the horizontal (panning) direction and the elevation-angle (tilting) direction according to a camera drive signal from the drive control unit 14. The counter 13 reads the angles ^{θ}i, ^{φ}i of the horizontal direction and the elevation-angle direction driven by the camera drive unit 12, and transmits the read values of the angles to the drive control unit 14. The drive control unit 14 drives the on-vehicle camera 10 precisely with the feedback signal, and stores the read data of the angles in a built-in memory.

The GPS unit 30 incorporates a GPS antenna and a timer, and receives the absolute time from the GPS satellite. The timer counts to synchronize with the absolute time received from the GPS satellite. Although it is impossible for the GPS unit 30 to receive the radio wave from the GPS satellite, the timer is able to supply the time information to the body unit 1 with stability owing to the counter operation. The timer is furnished with a function that corrects the counting time with a predetermined interval at the reception of the GPS radio wave.

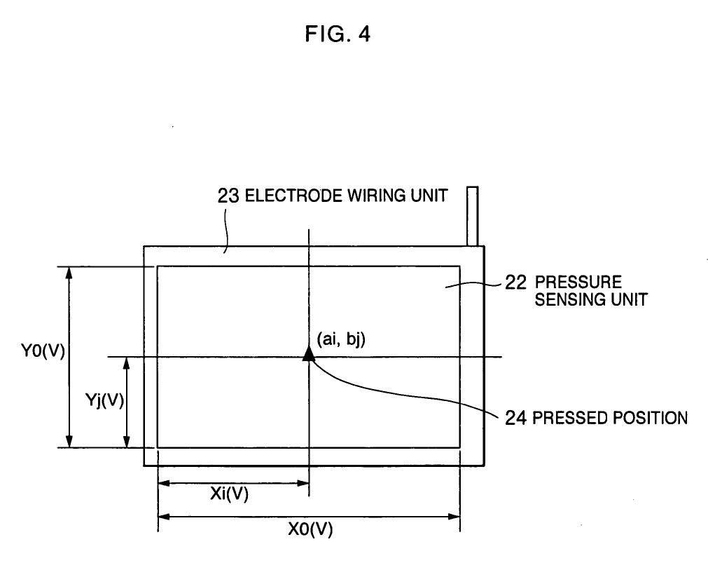

The display 20 is a crystal liquid display device, and has a touch panel 21 fixed on the front face of the display screen thereof. The touch panel 21 is made up of a pressure sensing units 22, in which two sheets of transparent electrode films are disposed to face to each other with a predetermined spacing, as shown in FIG. 4, and an electrode wiring unit 23 located on the periphery of the pressure sensing unit 22. And reference voltages X0 (V) and Y0 (V) are applied to the vertical direction and the horizontal direction of the panel. A pressure when a user presses the touch panel 21 is detected through the determination of measured voltages Xi (V) and Yi (V) when the panel is pressed. That is, the detection of pressure is determined when the measured voltages are higher than the predetermined voltages. A pressed position 24 is outputted as a correlative position coordinate (ai, bj) from the panel edges, according to the divided voltage ratios of the measured voltages Xi(V) and Yi (V) against the reference voltages X0 (V) and Y0 (V).

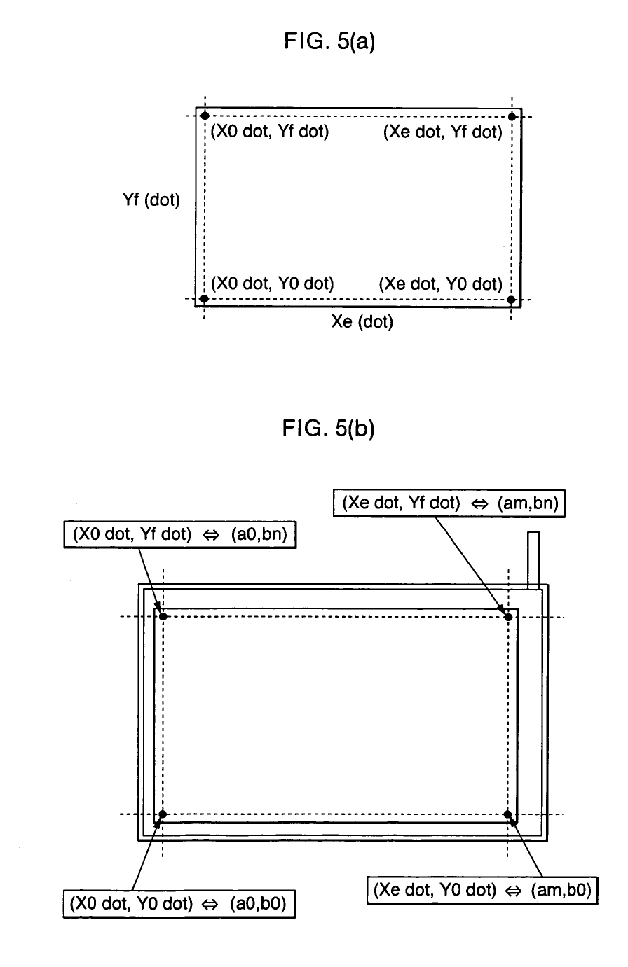

Now, the position detection on the display 20 by the touch panel 21 will be described. As shown in FIG. 5A, the absolute position on the display 20 is calculated by the counts of dot numbers Xe (dot), Yf (dot) from the edges. When the touch panel 21 is superposed on the display 20, the correlative position coordinate (ai, bi) measured by the touch panel 21 and the dot numbers Xe (dot), Yf (dot) of the display 20 are associated; and the result is recorded on a reference table 9a for TP coordinate and DP coordinate. As the method of the association, predetermined positions at four corners are associated as shown in FIG. 5B, for example, and on the assumption that the positions between them vary linearly, the coordinate corresponding values are recorded on the reference table 9a.

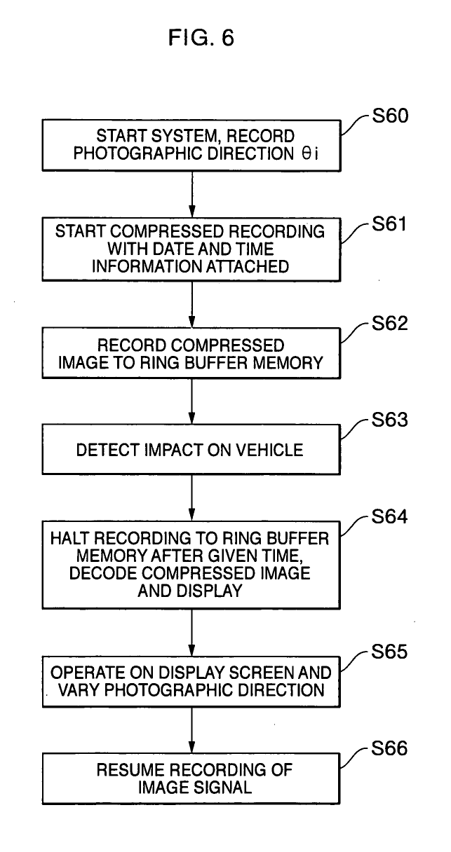

Next, the operation of the drive recorder in this embodiment will be described with FIG. 6. First, step S60 starts the system by starting the ACC (accessory) key of the vehicle. At this step, as already explained with FIG. 3, the photographic direction switch unit 11 reads the photographic direction ^{θ}i of the on-vehicle camera 10 at starting the system by means of the counter 13, and records it in the built-in memory of the drive control unit 14.

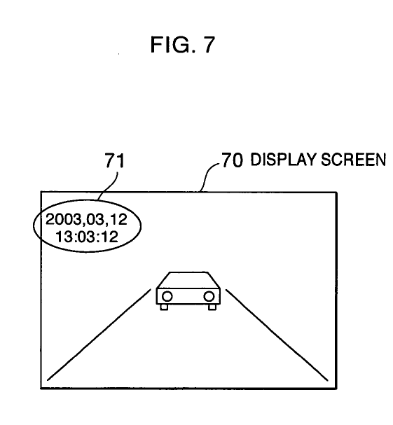

Step S61 records the video signal of an image photographed by the on-vehicle camera 10, on which is attached the time information at the moment of photographing. As the method of recording the video signal, the character display unit 2 superposes the time information captured by the GPS unit 30 at a given position 71 on a display screen 70, as shown in FIG. 7 for example, the encoder 3 compresses the video signal, and the control unit 7 records it in the built-in buffer memory 8. Next, step S62 records the recorded video signal in the buffer memory 4. Here, the buffer memory 4 is a memory of a ring buffer structure, which discards the oldest of the compressed video information among the stored information, and sequentially records the most recent information. Next at step S63, as the impact sensor 40 detects a given amount of impact on the vehicle, the control unit 7 determines that an accident has occurred, at step S64, halts the recording of the compressed video signal to the buffer memory 4 after a given time from the detection of the impact signal, and transfers the recorded image to the nonvolatile storage memory 6 such as a cash memory or a memory card. The image recorded in the storage memory 6 is taken out and reproduced when the accident is verified afterwards, and the circumstances leading to the occurrence of the accident are examined. Receiving an accident detection signal from the impact sensor 40, the control unit 7 switches the display 20 to the video input mode, and branches the video output recorded in the built-in buffer memory 8 of the control unit 7 to input it to the decoder 5. The decoder 5 expands the video signal, and displays it on the display 20. Step S65 varies the photographic direction of the on-vehicle camera 10 by the user pressing a specific place of the image on the touch panel 21, in a state that the image is displayed on the display 20. Step S66 records the image photographed by the on-vehicle camera 10 of which the photographic direction has been varied into the built-in buffer memory 8 of the control unit 7 with the time information at that moment attached, and transfers the recorded video signal to the buffer memory 4. The video signal recorded in the buffer memory 4 is stored in the storage memory 6 through the storage operation on the screen of the display 20, and is taken out from the storage memory 6.

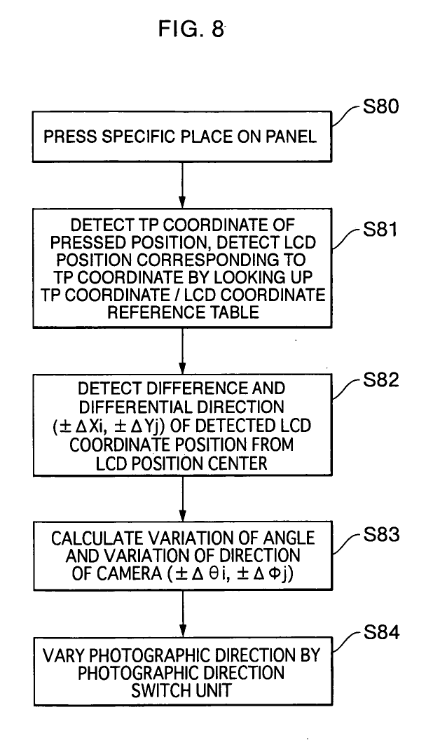

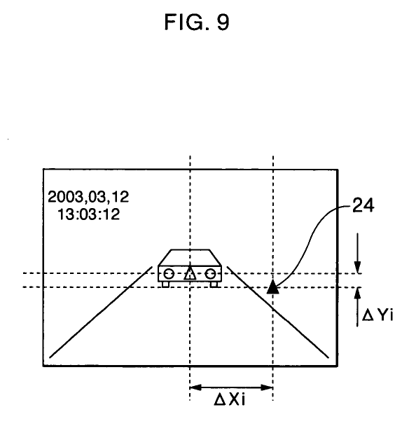

Now, the operation at step S65 will be described more in detail with FIG. 8. First at step S80, the user presses a specific place of the image by the on-vehicle camera 10 from the top of the touch panel 21, which is displayed on the screen of the display 20. Then at step S81, as explained with FIG. 4, the coordinate (ai, bj) of the pressed position on the touch panel 21 is detected, which is transferred to the control unit 7. The photographic direction control unit 9 looks up the TP coordinate/DP coordinate reference table 9a to detect the display DP coordinate (Xi, Yj) corresponding to the touch panel TP coordinate. Next at step S82, the photographic direction control unit 9 recognizes the center coordinate of the display 20 in advance, and is able to calculate the difference between the screen center and the pressed position and the differential direction (^{±Δ}Xi, ^{±Δ}Yj), as shown in FIG. 9. The differential direction is defined as positive when the pressed position is located on the right side and the upper side, viewed from the screen center, for example. Step S83 transmits the calculated values to the camera movement calculation unit 9b, and calculates camera movements (^{±Δθ}i, ^{±Δφ}j) The camera movement calculation unit 9b is made to calculate the relation between the differences (^{±Δ}Xi, ^{±Δ}Yj) of the display position and the camera movements (^{±Δθ}i, ^{±Δφ}j) of the on-vehicle camera 10; and it sets the calculation constants so that the image of the pressed position is located on the center of the display 20 as an example. Step S84 transmits the directions of movement and the movements of the on-vehicle camera 10 by the above calculation to the photographic direction switch unit 11, and drives the on-vehicle camera 10 according to the data. Here, the drive control unit 14 of the photographic direction switch unit 11 compares the current setting angles ^{θ}i, ^{φ}j of the camera with the permissible movement ranges ^{θ}0 to ^{θ}n, ^{θ}0 to ^{θ}m of the camera. If the transmitted camera movements ^{Δθ}i, ^{Δφ}j do not exceed (^{θ}n-^{θ}0), (^{φ}m-^{φ}0), the drive control unit 14 moves the camera by the specific movements. If they do, the drive control unit 14 does not move the on-vehicle camera 10, and warns the driver by making a buzzing sound, for example. When the drive control unit 14 moves the on-vehicle camera 10, the counter 13 reads the angle ^{θ}j, and records the data in the built-in memory of the drive control unit 14.

Thus, according to the embodiment 1, as the impact sensor 40 detects the occurrence of an accident, the control unit 7 displays the image by the on-vehicle camera 10 on the screen of the display 20. Accordingly, the user is able to quickly record the target objects that supposedly help to verify the cause of the accident, such as the vehicle running into from behind and running away, the traffic light, and the traffic sign and so forth, by simply turning the photographic direction of the on-vehicle camera 10 toward the objects, with a simple operation on the touch panel without any effort to find out the operation buttons and so forth in an emergency, especially in hurried circumstances immediately after the occurrence of the accident, thus attaining the useful data to serve for analyzing the cause of the accident.

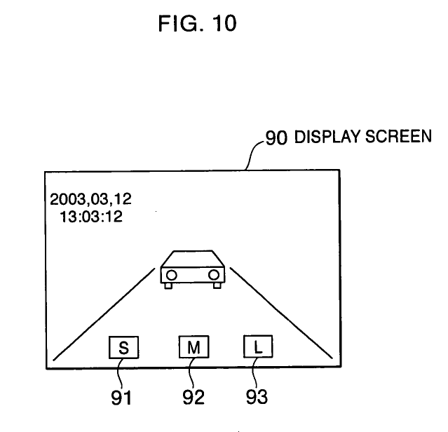

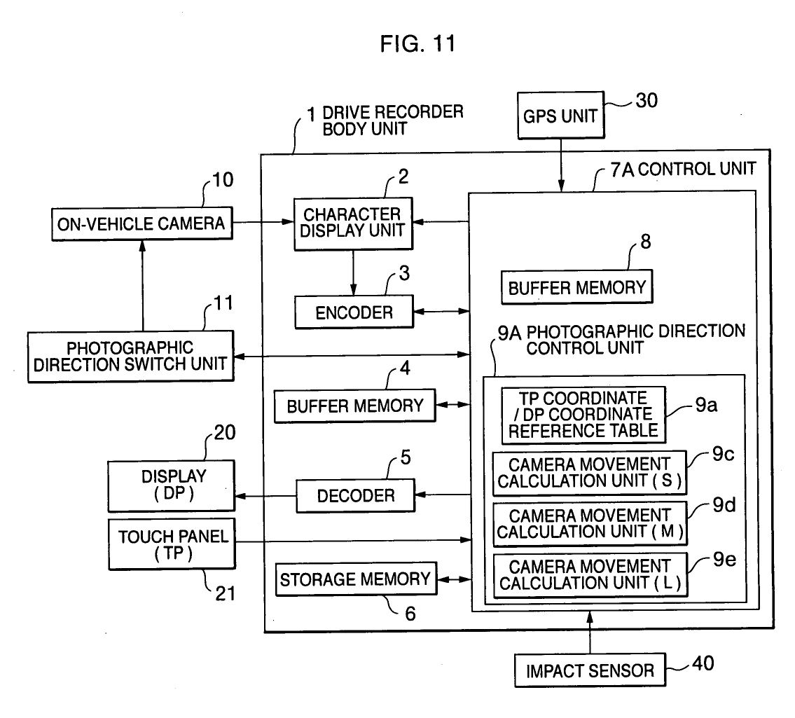

Here in the embodiment 1, the on-vehicle camera 10 may be designed such that the photographic magnification can be varied by the operation on the screen as shown in FIG. 10. In FIG. 10, an S button 91 on a display screen 90 is for reduction scale, an M button 92 is for normal scale, and an L button 93 is for expansion scale. In correspondence with the above magnification, the photographic direction control unit 9 of the control unit 7 modifies the configuration thereof, as shown in FIG. 11. That is, a photographic direction control unit 9A of a control unit 7A includes the TP coordinate/DP coordinate reference table 9a, a camera movement calculation unit 9c corresponding to the S button 91, a camera movement calculation unit 9d corresponding to the M button 92, and a camera movement calculation unit 9e corresponding to the L button 93. Thus, the photographic direction control unit 9A calculates the necessary movements of the on-vehicle camera 10 by the calculation unit corresponding to the button pressed.

(Embodiment 2)

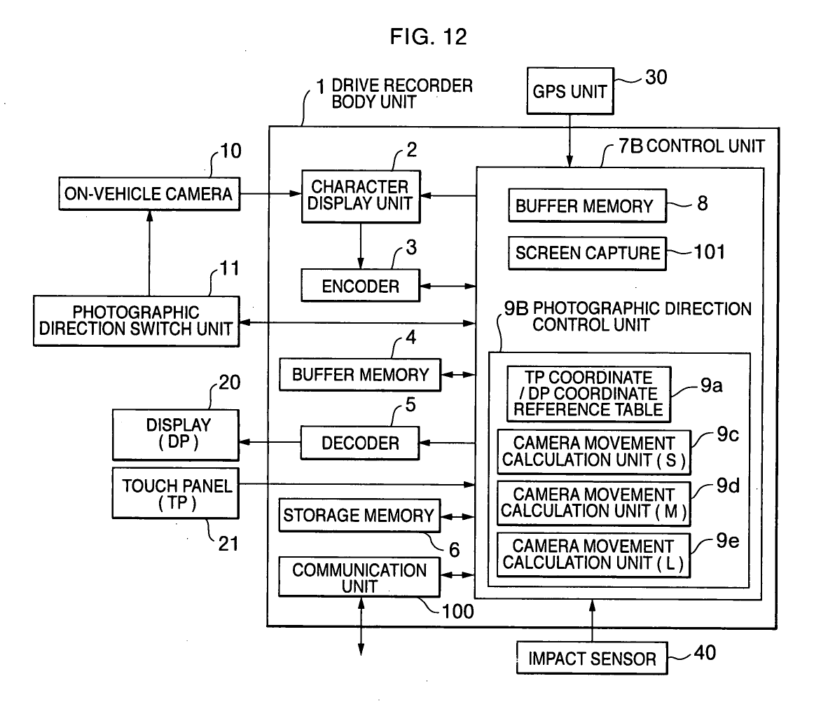

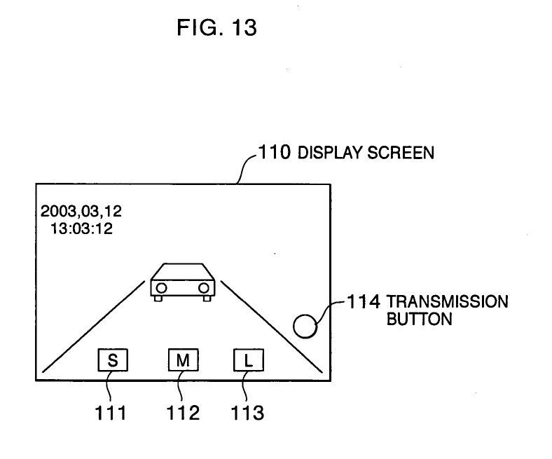

Next, the embodiment 2 of the invention will be described with reference to FIGS. 12 to 14. In addition to the configuration of the embodiment 1 shown in FIGS. 1 and 11, the drive recorder in the embodiment 2 includes a communication unit 100 that transmits data to an external organization such as the information center, a screen capture 101 that fetches an image on the display screen to a control unit 7B, and a photographic direction control unit 9B for making the photographic magnification of the on-vehicle camera 10 variable by operation on the screen. In this Embodiment 2, the on-vehicle camera 10 can as well have a configuration permitting alteration of the photographic magnification and, as shown in FIG. 13, the photographic magnification may be made variable by manipulating the display screen 110. Therefore, a transmission button 114 is displayed on a display screen 110, in addition to an S button 111, an M button 112, and an L button 113. Referring to FIG. 13, an S button 111 is for reduction scale, an M button 112, for the normal scale, and an L button 113, for expansion scale. To add, the photographic direction control unit 9B of the control unit 7B is provided with a TP coordinate/DP coordinate reference table 9a, a camera movement calculation unit 9c matching the S button 111, another camera movement calculation unit 9d matching the M button 112, and still another camera movement .calculation unit 9e matching the L button 113, and the photographic direction control unit 9B calculates the required movement of the on-vehicle camera 10 with the calculation unit matching the magnification of the pressed button.

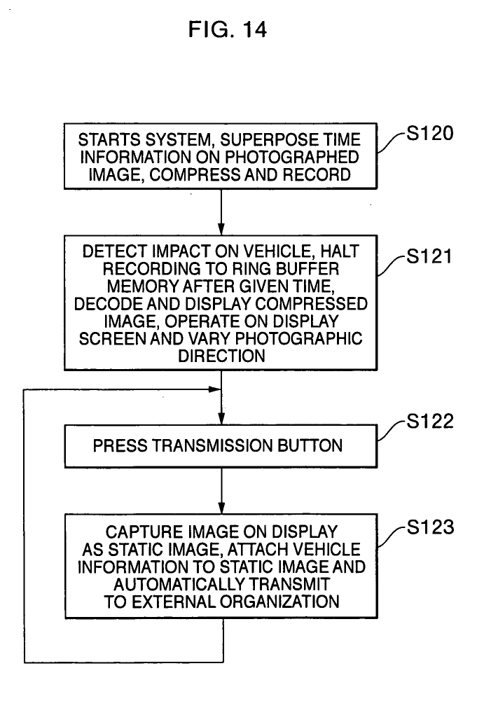

FIG. 14 shows the operation of the embodiment 2. In FIG. 14, first, as step S120 starts the system by starting the ACC (accessory) key of the vehicle, in the same manner as the embodiment 1, the photographic direction switch unit 11 reads the photographic direction of the on-vehicle camera 10 by means of the counter 13, and records it in the built-in memory of the drive control unit 14. The time information is superposed on the image by the on-vehicle camera 10, which is compressed and recorded in the ring buffer memory 4. Next, step S121 receives a signal from the impact sensor 40, halts the recording to the ring buffer memory 4 after a given time, and transfers the recorded image to the storage memory 6. The control unit 7B switches the display 20 to the video input mode, and branches the video output recorded in the built-in buffer memory 8 to input it to the decoder 5. The decoder 5 expands the video signal, and displays it on the display 20. In the state that this image is displayed, as the user presses a specific place on the screen, the photographic direction is switched, or the photographic magnification is switched by the operation of the magnification buttons 111 to 113.

Next, at step S122, as the user presses the transmission button 114, the screen capture 101 operates, whereby the display screen at the moment of the pressing is stored as a static image in the built-in buffer memory 8 of the control unit 7B. This static image is automatically transmitted to a predetermined external organization through the communication unit 100, with the information inherent to the vehicle attached. Since this operation can be made repeatedly, the user can appropriately record the scenic images surrounding the vehicle, the scenic images near or away from the vehicle, and the images inside the vehicle chamber, and transmit the data of the recorded images to the external organization. Thereby, the organization is able to attain the data for objectively determining the circumstances when the accident occurs.

Thus, according to the embodiment 2, the drive recorder includes the communication unit 100 that communicates with an external organization, and the screen capture 101 that fetches a screen presented on the display 20. The drive recorder records the image by the on-vehicle camera 10 presented on the display 20 as a static image, and transmits this static image with the information inherent to the vehicle attached to the external organization. This makes it possible to quickly transmit the useful images leading to verifying the cause of the accident to the external organization with a simple operation.

When receiving a detection signal from the impact sensor 40, the embodiment 1 and the embodiment 2 are configured to present on the display 20 the image for controlling the photographic direction of the on-vehicle camera 10. However, the configuration may be made such that the image by the on-vehicle camera 10 can be presented on the display 20 immediately after starting the system, and even before the occurrence of an accident, the photographic direction of the on-vehicle camera 10 can be operated in a desired direction. The switching of the on-vehicle camera 10 to the front, to the inside of the chamber, and to the rear is assumed to involve button displays on the screen of the display 20.

The embodiments being thus described, the invention makes it possible to securely record the image in a desired direction with a simple operation.

The invention being described based on the preferred embodiment illustrated in the drawings, it should be clear to a person having ordinary skill in the art that various modifications and changes are possible without a departure from the spirit and scope of the invention. The invention is to include such modifications and changes.

What is claimed is:

1. A drive recorder comprising:
a camera that photographs images of the outside or inside of a vehicle,
a recording unit that records images photographed by said camera,
a display that displays said recorded images on a screen, a touch panel, disposed on a front of the screen of said display, that outputs coordinate data of a position pressed, and
photographic direction variation means that vary a photographic direction of said camera in accordance with the position pressed on said touch panel.

2. The drive recorder according to claim 1, wherein the photographic direction variation means include:
a reference table that determines coordinates on said display screen corresponding to said position pressed, from the coordinates of the position pressed on said touch panel,
a camera movement calculation unit that calculates a movement of said camera from the coordinates on the display screen corresponding to said position pressed on the touch panel, and
a photographic direction switch unit that moves said camera on the basis of said movement calculated.

3. The drive recorder according to claim 2, wherein said photographic direction switch unit includes:
a drive control unit that receives a movement of the camera from said camera movement calculation unit to generate a camera drive signal,
a camera drive unit that drives the photographic direction of said camera in a horizontal direction and an elevation-angle direction, in accordance with the camera drive signal from said drive control unit, and
a counter that reads angles of the horizontal direction and the elevation-angle direction driven by said camera drive unit, and transmits read values of the angles to the drive control unit.

4. The drive recorder according to claim 2, further comprising photographic magnification switch means that switch a photographic magnification of said camera, wherein said camera movement calculation unit calculates a movement of the camera corresponding to said photographic magnification.

5. The drive recorder according to claim 3, further comprising photographic magnification switch means that switch a photographic magnification of said camera, wherein said camera movement calculation unit calculates a movement of the camera corresponding to said photographic magnification.

6. The drive recorder according to claim 1, further comprising a communication unit that communicates with an external organization, and screen capture means that fetch an image presented on said display, wherein the image by said camera presented on the display is recorded as a static image, and said communication unit transmits said static image with information inherent to the vehicle attached.

7. The drive recorder according to claim 2, further comprising a communication unit that communicates with an external organization, and screen capture means that fetch an image presented on said display, wherein the image by said camera presented on said display is recorded as a static image, and said communication unit transmits said static image with information inherent to the vehicle attached.

8. The drive recorder according to claim 3, further comprising a communication unit that communicates with an external organization, and screen capture means that fetch an image presented on said display, wherein the image by said camera presented on said display is recorded as a static image, and said communication unit transmits said static image with information inherent to the vehicle attached.

9. The drive recorder according to claim 4, further comprising a communication unit that communicates with an external organization, and screen capture means that fetch an image presented on said display, wherein the image by said camera presented on said display is recorded as a static image, and said communication unit transmits said static image with information inherent to the vehicle attached.

10. The drive recorder according to claim 5, further comprising a communication unit that communicates with an external organization, and screen capture means that fetch an image presented on said display, wherein the image by said camera presented on said display is recorded as a static image, and said communication unit transmits said static image with information inherent to the vehicle attached.
